(19) United States
(12) Patent Application Publication
(10) Pub. No.: US 2005/0219308 A1
(43) Pub. Date: Oct. 6, 2005

(54) Cap for ink jet head

(75) Inventor: Atsuhisa Nakashima, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/086,753

(22) Filed: Mar. 23, 2005

(30) Foreign Application Priority Data
Mar. 23, 2004 (JP) 2004-084488

(51) Int. Cl. B41J 2/165

(52) U.S. Cl. 347/29

(57) ABSTRACT

A cap for sealing nozzles of ink jet head of ink jet printer has a sheet member, a capping member, a detachment preventing member, and a linking member. The capping member is provided on one face of the sheet member, and the detachment preventing member is provided on the other face of the sheet member. The capping member and the detachment preventing member are linked by the linking member that passes through the sheet member.

### CROSS-REFERENCE TO RELATED APPLICAION

This application claims priority to Japanese Patent Application No. 2004-084488, filed on Mar. 23, 2004, the contents of which are hereby incorporated by reference into the present application.

### BACKGROUND OF THE INVENTION

1. Field of the Invention

The present invention relates to a cap for an ink jet head mounted in an ink jet printer.

2. Description of the Related Art

An ink jet head mounted in an ink jet printer is provided with a nozzle for discharging ink. Since the nozzle is exposed to the atmosphere, there is a risk that when no ink is discharged for a long period, ink within the nozzle may dry out and block the nozzle. In a conventional ink jet head, the nozzle is formed on an ink discharging face. The ink jet printer is provided with a cap that fits tightly with the ink discharging face, thus isolating the ink discharging face from the atmosphere. Covering the ink discharging face with the cap prevents ink within the nozzle from drying out.

One example of a cap for an ink jet head is set forth in Japanese Laid-Open Patent Application Publication 2001-253080. In this technology, a cap is formed with a sheet member and a capping member provided on a surface of the sheet member. The capping member is capable of fitting tightly with an ink discharging face. The cap is configured such that it can move between a location where it fits tightly with the ink discharging face and a location where it is distant from the ink discharging face.

### BRIEF SUMMARY OF THE INVENTION

There is a risk, with the conventional cap, of the capping member becoming detached from the sheet member. In particular, in a case where the cap is configured such that it is moved between the location where the cap fits tightly with the ink discharging face and the location where the cap is distant from the ink discharging face by means of a belt, a wire, or the like, which is wound across a plurality of pulleys, the pulleys alter the direction of movement of the cap. Since the cap is bent when turning around the pulley, the capping member can readily peel away from the sheet member.

The invention provides a cap for an ink jet head, the cap being improved such that the capping member does not readily become detached from the sheet member.

A cap of an embodiment of the present invention has a sheet member, a capping member, a detachment preventing member, and a linking member. The capping member is provided on one face of the sheet member, and the detachment preventing member is provided on the other face of the sheet member. The capping member and the detachment preventing member are linked by the linking member that passes through the sheet member.

The capping member is supported, by means of the linking member and the detachment preventing member, from the face at the opposite side of the sheet member. Consequently, the capping member does not readily become detached from the sheet member.

The present invention can be understood fully by reading the embodiments described below while referring to the figures. The embodiments below are specific examples for practicing the present invention, but these merely illustrate some possibilities of the invention and do not restrict the claims thereof.

### BRIEF DESCRIPTION OF THE DRAWINGS

FIG. 1 shows a front view of essential parts of an embodiment of an ink jet printer in a state where a cap is in a retreated location.

FIG. 2 shows an enlargement of the vicinity of a driven roller.

FIG. 3 shows a surface face of the cap and a portion of a mechanism for moving the cap.

FIG. 4 shows an inside face of the cap.

FIG. 5 shows an enlargement of one capping portion of the cap of FIG. 3 and an ink discharge face of an ink jet head.

FIG. 6 shows a cross-sectional view along the line VI-VI of FIG. 5. FIG. 6 also shows a portion of a mechanism for pressing the cap towards the ink discharge face of the ink jet head.

FIG. 7 shows a front view of essential parts of the embodiment of the ink jet printer in a state where the cap is being moved from the retreated location to a sealing location.

FIG. 8 shows a front view of a delivery unit in a state where the cap is in the sealing location.

FIG. 9 shows a process of integrally molding a capping member, a detachment preventing member and a linking member.

FIG. 10 is a cross sectional view of a cap of a different embodiment.

### DETAILED DESCRIPTION OF PREFERRED EMBODIMENTS

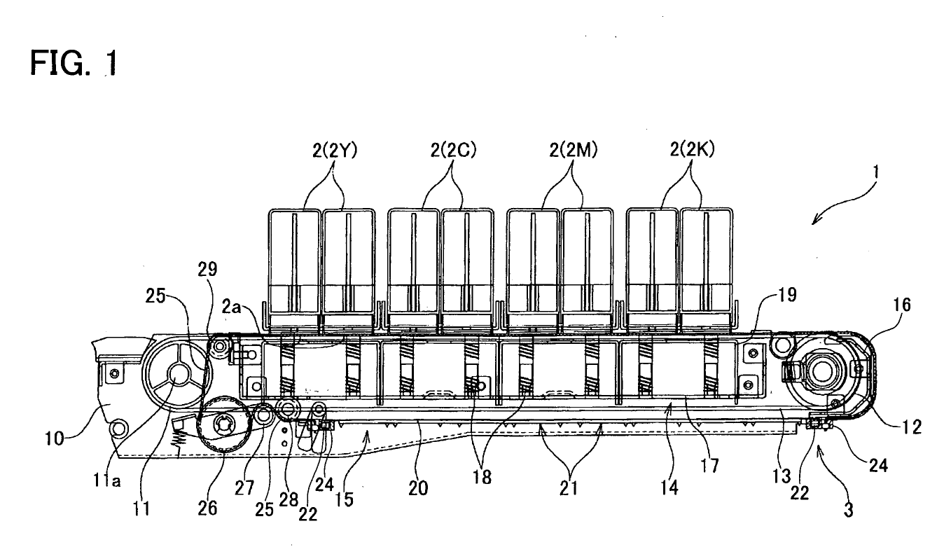

A preferred embodiment to practice the present invention will now be described. In the present embodiment, the present invention has been applied to a line type color ink jet printer. However, the present invention can also be applied to other types of ink jet printers. As shown in FIG. 1, an ink jet printer 1 is provided with a total of eight line type ink jet heads 2. Two ink jet heads 2K discharge black ink, two ink jet heads 2M discharge magenta ink, two ink jet heads 2C discharge cyan ink, and two ink jet heads 2Y discharge yellow ink. The ink jet printer 1 is also provided with a delivery unit 3 that delivers paper in the leftwards direction of FIG. 1. The eight ink jet heads 2 are aligned in a left-right direction of FIG. 1 (along the direction of delivery of the paper).

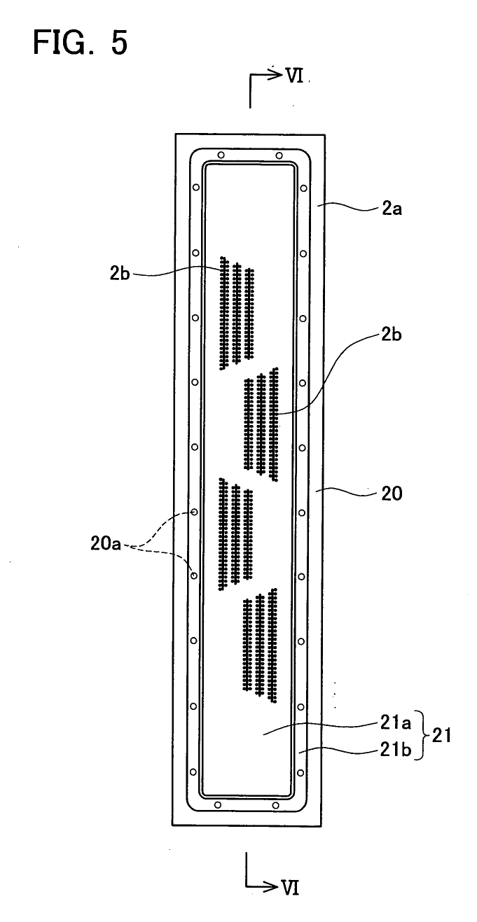

An ink discharging face 2a is formed at a lower face of each ink jet head 2. As shown in FIG. 5, a plurality of holes 2b is formed in each ink discharge face 2a of each ink jet head 2. Each hole 2b works as a nozzle for discharging ink. The plurality of the nozzles 2b is divided into four groups, and the nozzles 2b of each group are distributed within a trapezoid area. Four trapezoid areas are arranged in an inner region of the ink discharge face 2a, and no nozzles 2b is arranged in an outer boundary region of the ink discharge face 2a. A later described lip member 21b will fits tightly with the outer boundary region having no nozzles 2b for sealing nozzles 2b from the atmosphere.

In FIG. 1, a paper feed tray (not shown) is present at a right side of the ink jet heads 2, and a paper discharge tray (not shown) is present at a left side of the ink jet heads 2. The delivery unit 3 takes paper from the paper feed tray, passes the paper below the ink jet heads 2, and sends it to the paper discharge tray. Ink is discharged from the ink jet heads 2, and printing of the paper passing below the ink jet heads 2 is thus performed.

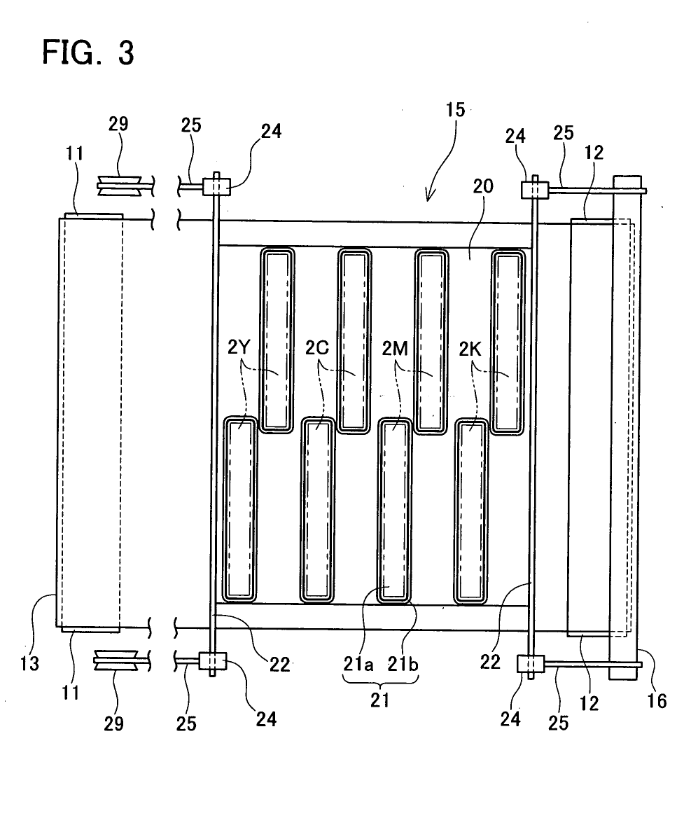

Both ink jet heads (2K, 2M, 2C, and 2Y) that discharge identically colored ink are adjacent in the direction of delivery of the paper. Each ink jet head 2 extends in a direction orthogonal to the page of FIG. 1, and extends for a length equivalent to approximately half the width of the paper. Both ink jet heads discharging identically colored ink are disposed in locations having displacement therebetween in a direction orthogonal to the page of FIG. 1. As shown in FIG. 3, both ink jet heads 2 discharging identically colored ink are disposed such that end parts thereof overlap when viewed from a direction orthogonal to the paper. Both ink jet heads 2 discharging identically colored ink are used for printing the paper. This allows the entire width of the paper passing below the ink jet heads 2 to be printed at the same time. The two ink jet heads 2 discharging identically colored ink have no space therebetween which would cause a blank area in the printing.

As shown in FIG. 1, the delivery unit 3 is provided with two rollers 11 and 12 supported in a manner allowing rotation in a main body frame 10, a continuous carrier belt 13 wound across the rollers 11 and 12, and a belt receiving unit 14 that engages with the carrier belt 13 from below. The belt receiving unit 14 prevents the carrier belt 13 from bending downwards between the rollers 11 and 12. The belt receiving unit 14 thus enables the carrier belt 13 to move horizontally. The delivery unit 3 does not only deliver paper, but is also provided with a cap 15 for covering the ink discharging faces 2a of the ink jet heads 2, and with a mechanism for moving this cap 15.

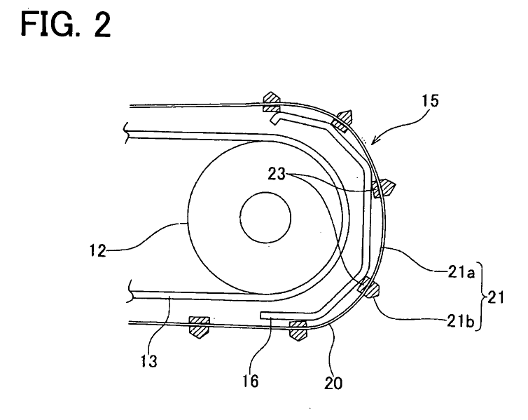

The roller 11, which is a driving roller, is linked with a motor (not shown). Driving force of the motor is transmitted to the driving roller 11, thus rotating and driving the driving roller 11. Thereupon, the carrier belt 13 moves between the driving roller 11 and the roller 12 (a driven roller), and paper mounted on the carrier belt 13 is delivered from right to left relative to FIG. 1. Moreover, as shown in FIGS. 1 and 2, a guide member 16 is formed at the right side (relative to FIG. 1) of the driven roller 12. The guide member 16 is approximately semicircular when viewed frontally. As the driven roller 12 rotates, the guide member 16 guides movement such that the carrier belt 13 moves, and the paper is delivered.

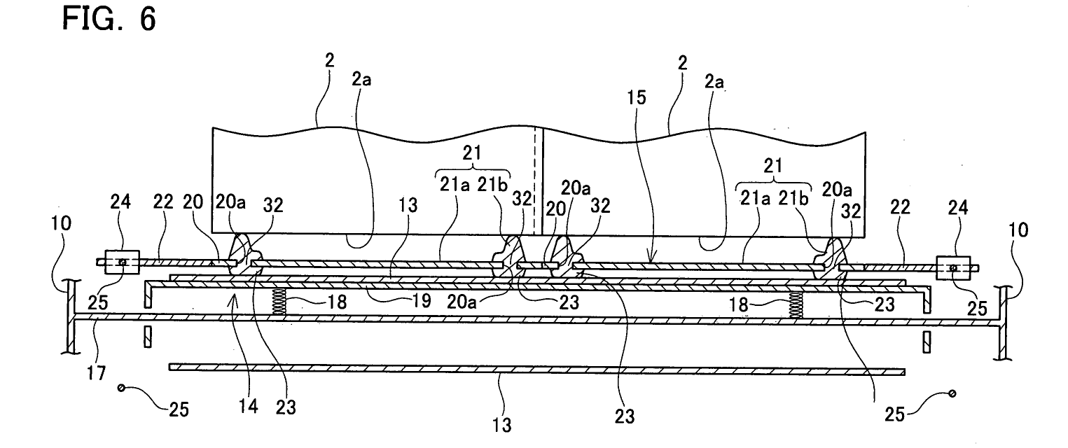

As shown in FIGS. 1 and 6, the belt receiving unit 14 has a base 17 formed in a fixed manner in the main body frame 10, and has a belt receiving member 19 supported by the base 17 via a plurality of compression springs 18. The carrier belt 13 slides along an upper face of the belt receiving member 19. The belt receiving unit 14 supports the carrier belt 13 from below. Further, as will be described in detail later, when the cap 15 has been mounted below the ink jet heads 2, the energizing force of the compression springs 18 of the belt receiving unit 14 presses the cap 15 against the ink discharging faces 2a of the ink jet heads 2 via the carrier belt 13.

The cap 15 fits tightly with the ink discharging faces 2a of the ink jet heads 2 to prevent ink in the nozzles 2b of the ink jet heads 2 from drying out, and to recover ink discharged from the nozzles 2b during a purging process. As shown in FIGS. 3 to 6, the cap 15 has a sheet member 20 and eight capping portions 21. The capping portions 21 are disposed on one face of the sheet member 20 and each of capping portions 21 can fit tightly with each of the ink discharging faces 2a of each of the ink jet heads 2. Further, the cap 15 has a detachment preventing member 23 provided at the other face of the sheet member 20 and linking members 32. The linking members 32 pass through the sheet member 20 and link the capping portions 21 and the detachment preventing member 23.

The sheet member 20 is formed from a flexible material with a low elongation percentage, such as polyimide, polyester, or the like. The sheet member 20 does not allow the air to pass through. As shown in FIGS. 1, 3, and 4, the sheet member 20 is formed in a sheet shape and, from a plan view, has a rectangular shape. The eight capping portions 21 formed on one face of the sheet member 20 are disposed in locations corresponding to the eight ink jet heads 2. The capping member of the embodiment includes eight capping portions 21.

As shown in FIGS. 3 to 6, each capping portion 21 is provided with a base member 21a and a lip member 21b. Each base member 21a is formed by a portion of the sheet member 20, and has a plane rectangular shape slightly larger than a plane shape of a region where the nozzles 2b are distributed on the ink discharging face 2a. The lip member 21b surrounds the circumference of the base member 21a in a frame shape that corresponds to the outer boundary region of the ink discharge face 2a. The lip member 21b rises above the sheet member 20. The lip members 21b are molded from soft synthetic resin, and adhered to the sheet member 20. The lip member 21b is softer than the sheet member 20 and easily deformable due its elasticity. The lip member 21b does not allow the air to pass through. The material of the sheet member 20 is selected to be suitable to the sheet member 20, and the material of the lip member 21b is selected to be suitable to the lip member 21b. The materials of the sheet member 20 and the lip sheet member 21b are different.

When the lip member 21b is pressed against the ink discharge face 2a, the lip member 21b deforms resiliently while fitting tightly with the outer region of the ink discharging face 2a, thus the capping portion 21 reliably seals the nozzles 2b distributed on the ink discharge face 2a from the atmosphere.

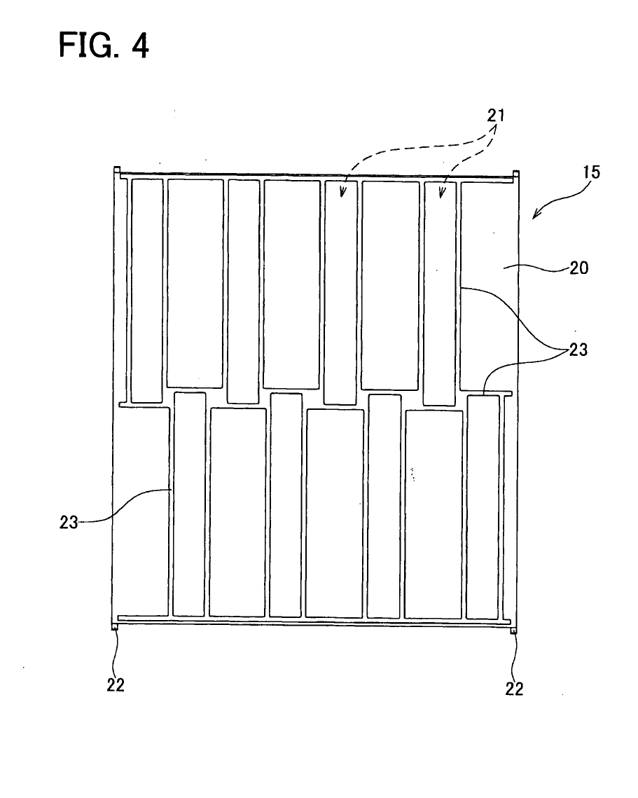

As shown in FIGS. 4 and 6, the detachment preventing member 23 is provided on the other face of the sheet member 20. The detachment preventing member 23 includes eight detachment preventing portions. The shape and location of each of the detachment preventing portions correspond to those of each of the capping portions 21. The eight detachment preventing portions are mutually connected to form the single common detachment preventing member 23. That is, a total of eight detachment preventing portions are all linked integrally.

As shown in FIG. 6, the capping portions 21 formed on one face of the sheet member 20, and the detachment preventing member 23 formed on the other face of the sheet member 20, are linked by the linking members 32 that pass through the sheet member 20. A plurality of holes 20a (see FIGS. 5 and 6) is formed in the sheet member 20 in regions that, from a plan view, overlap with the lip members 21b. The linking members 32 pass through these holes 20a to link the capping portions 21 and the detachment preventing member 23. In FIG. 5, the holes 20a should rightfully be shown by a dotted line. However, a solid line has been drawn for the sake of clarity.

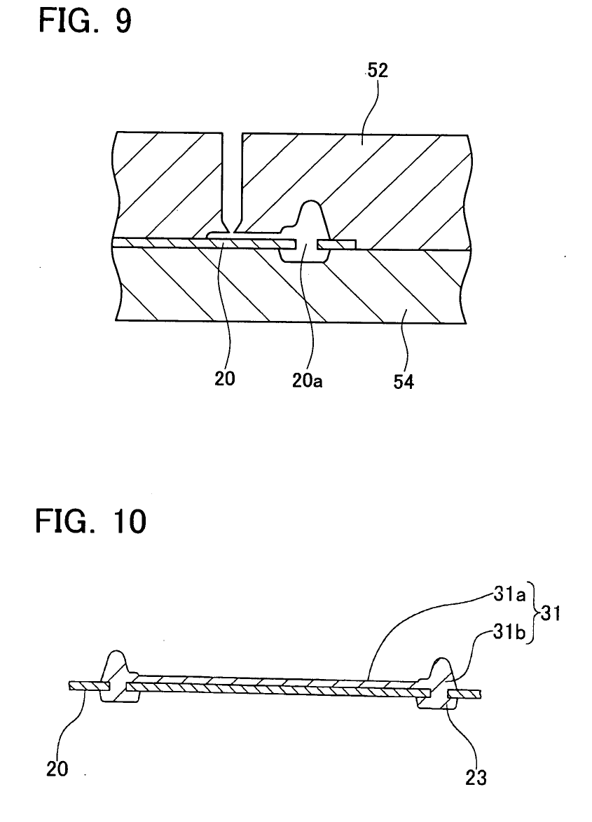

The lip members 21b, the detachment preventing member 23, and the linking portions 32 are molded integrally by means of injection molding. As shown in FIG. 9, by injecting soft rubber-like synthetic resin into a cavity of a molding die having an upper die 52 for forming the lip member 21b and lower die 53 for forming the detachment preventing member 23 in a state that the seat member 20 having holes 20a is set between the upper die 52 and the lower die 54, the lip members 21b, the detachment preventing member 23, and the linking members 32 are molded integrally.

Since the lip members 21b are linked with the detachment preventing member 23 located on the opposite side of the sheet member 20, and the sheet member 20 is held between these two, the lip members 21b do not readily become detached from the sheet member 20.

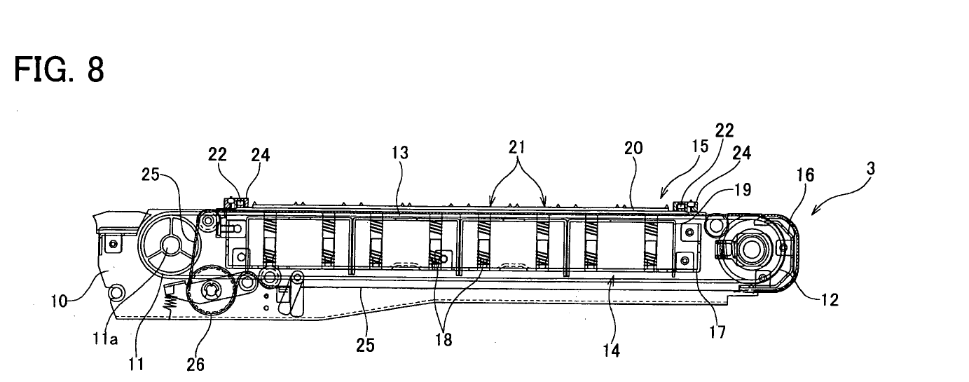

An inside face of the sheet member 20 slides on the guide member 16 when the cap 15 is moved. At the surface of the sheet member 20 that slides on the guide member 16, the detachment preventing member 23 for the eight capping portions 21 is linked integrally, and the face is substantially flat. When the cap 15 is moved between a sealing location (to be described: see FIG. 8) and a retreated location (see FIG. 1), the cap 15 bends during this movement. Simultaneously, as shown in FIG. 2, the detachment preventing member 23 makes contact with the guide member 16. Since the detachment preventing member 23 is formed integrally and the surface thereof is substantially flat, the cap 15 can be moved smoothly across the guide member 16.

As shown in FIGS. 3 and 4, a pair of sheet supporting bars 22 is formed at both end portions of the sheet member 20 in a left-right direction relative to FIG. 3 (the direction of delivery of the paper). The sheet supporting bars 22 are formed from metal and have a narrow line shape. As shown in FIG. 1, the delivery unit 3 is provided with belts 25. The belts 25 are formed at a closer side and a further side (relative to the page of FIG. 1) of the paper carrier belt 13. One end of the sheet supporting bar 22 is linked with the belt 25 of the closer side via a connecting member 24 and the other end part of the sheet supporting bar 22 is linked with the belt 25 of the further side via the connecting member 24. The belts 25 are wound across four pulleys 26, 27, 28, and 29 and an outer circumference of the guide member 16. The pulleys 26, 27, 28, and 29 are formed at a left side portion of the main body frame 10, and the guide member 16, which is semicircular when viewed frontally, is formed at the right side of driven roller 12. When the pulley 26 is caused to rotate by a motor (not shown) linked with this pulley 26, the belts 25 on both sides rotate, and the cap 15 moves therewith. The cap 15 moves along an outer side of the carrier belt 13.

The cap 15 is moved by the belts 25 between the sealing location (see FIG. 8) and the retreated location (see FIG. 1). In the sealing location, the cap 15 is located between the ink discharge faces 2a of the ink jet heads 2, and the carrier belt 13. As shown in FIG. 8, the cap 15 is located above the carrier belt 13. In FIG. 8, the ink jet heads 2 have been omitted and only the delivery unit 3 is shown so that the location of the cap 15 is shown more clearly. In the sealing location, the capping portions of the capping member 21 face the ink discharging faces 2a of the ink jet heads 2, and can seal the ink jet nozzles 2b distributed on the ink discharging faces 2a.

In the retreated location, the cap 15 is located below the carrier belt 13 (see FIG. 1). In the retreated location, the carrier belt 13 directly faces the ink discharging faces 2a of the ink jet heads 2 via the printing paper, so that ink discharged from the ink jet heads 2 is injected onto the printing paper, and printing of the paper passing below the ink jet heads 2 is thus performed.

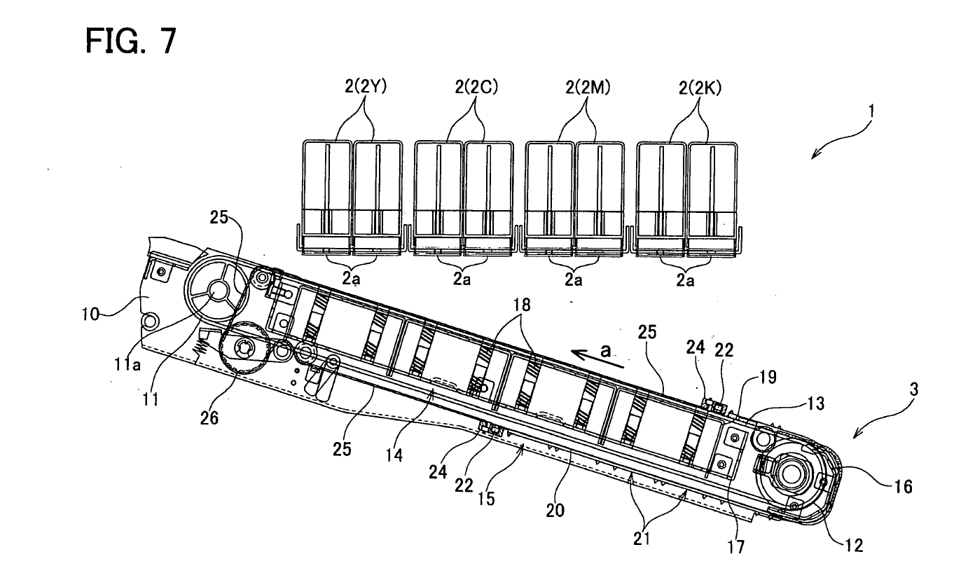

As shown in FIG. 7, the main body frame 10 of the delivery unit 3 can be swung along a vertical plane, with a rotational axis 11a of the driving roller 11 as the center, by means of a swinging device (not shown). Further, the main body frame 10 of the delivery unit 3 can be raised and lowered relative to the ink jet heads 2 by means of a raising and lowering mechanism (not shown).

In the case where the ink discharging faces 2a are to be sealed by the cap 15, the main body frame 10 is first rotated by the swinging device in a clockwise direction relative to FIG. 1, with the rotational axis 11a as the center, until the delivery unit 3 has been swung to the location in FIG. 7. In this state, the pulley 26 is rotated. This moves the cap 15, via the belts 25, along the outer side of the carrier belt 13 (see FIG. 7) until the cap 15 is located above an upper side of the carrier belt 13. FIG. 7 shows a state where the cap 15 is being moved from the retreated position to the sealing position. The cap 15 is bent while moving from the retreated position to the sealing position. When the cap 15 is further moved along the arrow “a”, the cap 15 reaches the sealing position as shown in FIG. 8. Then the main body frame 10 is rotated by the swinging device in an counterclockwise direction relative to FIG. 1, with the rotational axis 11a as the center, until the delivery unit 3 has been swung to the location in FIG. 8. In the location shown in FIG. 8, the capping members 21 face the ink jet heads 2. Moreover, the main body frame 10 is moved upwards, relative to the ink jet heads 2, by the raising and lowering mechanism (not shown). As a result, as shown in FIG. 6, the energizing force of the compression springs 18 of the belt receiving unit 14 presses the capping members 21 of the cap 15, located on the upper side of the carrier belt 13, against the ink jet heads 2. The ink discharging nozzles 2b at the ink discharging faces 2a are thus sealed by the capping members 21.

When the cap 15 is to be moved between the sealing location (see FIG. 8), in which the capping members 21 face upwards (facing the ink jet heads 2) and the retreated location (see FIG. 1), in which the capping members 21 face the opposite side from the ink jet heads 2, the cap 15 slides on the outer circumference part of the guide member 16. At this juncture, the direction of movement of the cap 15 changes from horizontal to vertical, thus necessitating a bending of the cap 15. If the lip members 21b of the capping members 21 were bonded to the sheet member 20 only by means of adhesive or the like, there would be considerable risk of the lip members 21b becoming detached from the sheet member 20 when the cap 15 bends. Further, the lip members 21b would also readily become detached when the lip members 21b are removed from the ink discharging faces 2a of the ink jet heads 2.

As shown in FIGS. 4 and 6, in the cap 15 of the present embodiment, the capping members 21 (the lip members 21b) are linked with the detachment preventing member 23 located on the opposite face of the sheet member 20 relative to the capping members 21, and the sheet member 20 is held between these two parts. This prevents the capping members 21 from becoming detached from the sheet member 20.

There may be no risk of the lip members 21b being detached from the sheet member 20, if the lip members 21b and the sheet member 20 are integrally formed. However, the sheet member 20 must be formed from a material having a low elongation percentage. If the sheet member 20 is elongated, the sheet member 20 can not be moved by the rotation of the pulley 26. On the contrary, the lip members 21b must be formed from a soft rubber-like material. In the embodiment, the sheet member 20 made from the suitable material for the sheet member 20 and the lip member 21b made from the suitable material for the lip member 21b, the materials being different, can be held tightly.

Next, variations on the above embodiment will be described. Components configured identically to those of the above embodiment have the same reference numbers assigned thereto and a description thereof is omitted.

The shape of the capping member or the detachment preventing member is not limited to the shape in the above embodiment. For example, as shown in FIG. 10, a capping member 31 may have a base member 31a that overlaps with the sheet member 20, and a lip member 31b that surrounds a circumference of the base member 31a, with the base member 31a and the lip member 31b being molded integrally from soft synthetic resin. If the capping member 31 has this structure, the capping member 31 fits more tightly to the ink discharging face 2a. The lip member 31b and the detachment preventing member 23 may be molded integrally, as is the case in the above embodiment. However, the base member 31a and the detachment preventing member 23 may equally well be molded integrally. In this case, also, the capping member 31 at the surface face side and the detachment preventing member 23 at the inside face side are linked by the linking member 32 that passes through the sheet member 20. The detachment of the capping member 31 is thus prevented.

The detachment preventing member may project beyond an area corresponding to the inside side of the lip members 21b and 31b, and may be formed across approximately the entirety of the inside face of the sheet member 20. In this case, an inside face side of the cap is also flat, and the cap can consequently move more smoothly.

The moving means of the cap is not limited to the belts 25 of the embodiment. For example, the cap may be moved between the sealing location and the retreated location via a line-shaped member, such as a wire or the like, wound across a plurality of pulleys. Moreover, a configuration is also possible in which the sealing location and the retreated location are located within an identical horizontal plane, and the cap can be moved within this plane between the sealing location and the retreated location.

According to an exemplary embodiment, it is preferred that the capping member, the linking member, and the detachment preventing member are molded integrally. The capping member, the linking member, and the detachment preventing member can be molded integrally by setting the sheet member, which has holes dispersed in a region of forming the capping member, in an injection molding die and performing injection molding thereof. This integral molding prevents the capping member from readily becoming detached from the sheet member.

According to an exemplary embodiment, a plurality of ink jet heads may be mounted in an ink jet printer. In this case, the capping member may be provided with a plurality of capping portions that is disposed on one face of a single sheet member. Each capping portion fits tightly with each ink discharging face of each ink jet head. The detachment preventing member may be provided with a plurality of detachment preventing portions that is disposed on the other face of the single sheet member. Each detachment preventing portion corresponds to each capping portion. In this case, it is preferred that the detachment preventing portions that correspond to the capping portions are formed continuously, such that a single common detachment preventing member is formed.

According to an exemplary embodiment, in this case, each capping portion is linked with the large common detachment preventing member, and the capping portions consequently become detached from the sheet member even less readily. Further, a surface of the detachment preventing member can consequently be almost flat. As a result, each capping portion can easily be fitted tightly with the corresponding ink discharging face.

According to an exemplary embodiment, the cap is particularly useful when the cap is integrated with a mechanism that moves the cap, utilizing a belt or a wire wound across a plurality of pulleys, between a location where the cap fits tightly with the ink discharging face and a location where the cap is distant from the ink discharging face.

According to an exemplary embodiment, in the case where the cap is moved utilizing a belt or a wire wound across a plurality of pulleys, the capping member or capping portions tend to readily become detached from the sheet member when the pulleys cause the cap to bend. In the cap of an exemplary embodiment of the present invention, however, the detachment preventing member or detachment preventing portions support the capping member or capping portions from the face at the opposite side of the sheet member, with the sheet member being held between the capping member and the detachment preventing member. This reliably prevents the capping member or capping portions from becoming detached from the sheet member. According to an exemplary embodiment, in the case where the cap is moved utilizing a belt or a wire wound across a plurality of pulleys, it is particularly preferred that the detachment preventing portions are mutually connected, such that a single common detachment preventing member is formed. A surface of the detachment preventing member can consequently be almost flat, and consequently it is easy to move the cap smoothly around pulleys.

1. A cap for sealing nozzles of an ink jet head for discharging ink, the cap comprising:
a sheet member;
a capping member formed on one face of the sheet member, the capping member being capable of fitting tightly with an ink discharging face on which the nozzles are formed;
a detachment preventing member formed on the other face of the sheet member; and
a linking member passing through the sheet member and linking the capping member and the detachment preventing member.

2. A cap of claim 1,
wherein the capping member, the detachment preventing member, and the linking member are molded integrally.

3. A cap of claim 1,
wherein the capping member includes a plurality of capping portions that is provided on one face of the sheet member, and the detachment preventing member includes a plurality of detachment preventing portions that is provided on the other face of the sheet member, and
wherein the detachment preventing member includes a plurality of detachment preventing portions, wherein each of the detachment preventing portions is connected to each of the respective capping portions.

4. A cap of claim 1,
wherein the capping member includes a plurality of capping portions that is provided on one face of the sheet member,
wherein the detachment preventing member is formed with a single common detachment preventing member, and
wherein the plurality of capping portions is linked with the detachment preventing member.

5. A cap of claim 1,
wherein the cap is linked with a belt or a wire wound across a plurality of pulleys, and
wherein the cap is moved by means of the belt or the wire between a sealing location wherein the cap fits tightly with the ink discharging face and a retreated location wherein the cap is distant from the ink discharging face.

6. A cap of claim 3,
wherein the cap is linked with a belt or a wire wound across a plurality of pulleys, and
wherein the cap is moved by means of the belt or the wire between a sealing location, wherein the cap fits tightly with the ink discharging face, and a retreated location wherein the cap is distant from the ink discharging face.
